(19) United States
(12) Patent Application Publication
(10) Pub. No.: US 2005/0063875 A1
(43) Pub. Date: Mar. 24, 2005

(54) Micro-fluidic processor

(75) Inventors: Michael F. Schatz, Atlanta, GA (US); Roman O. Grigoriev, Marietta, GA (US)

Correspondence Address: Scott A. Horstemeyer, Esq.;Thomas, Kayden, Horstemeyer & Risley, LLP, Suite 1750, 100 Galleria Parkway, N.W., Atlanta, GA, 30339-5948, US

(73) Assignee: Georgia Tech Research Corporation, Atlanta, GA (US)

(21) Appl. No.: 10/858,027

(22) Filed: Jun. 1, 2004

Related U.S. Application Data
(60) Provisional application No. 60/504,886, filed on Sep. 22, 2003.

(51) Int. Cl. G01N 1/10

(52) U.S. Cl. 422/100; 436/180

(57) ABSTRACT

A fluidic processor includes a substrate that receives a fluid and an optical surface-tension gradient inducer. The optical surface-tension gradient inducer is adapted to optically induce a gradient in surface tension of a fluid received by the substrate. Controlling surface tension gradients in a fluid provides a way of manipulating the fluid.

### CROSS-REFERENCE TO RELATED APPLICATION

This application claims priority to co-pending U.S. provisional application entitled, “Thermocapillary-Based Opto-Fluidics, Opto-Microfluidics, and Optically-Controlled Patterning and Coating,” having Ser. No. 60/504,886, filed Sep. 22, 2003, which is entirely incorporated herein by reference.

### STATEMENT REGARDING FEDERALLY SPONSORED RESEARCH OR DEVELOPMENT

The U.S. government may have a paid-up license in this invention and the right in limited circumstances to require the patent owner to license others on reasonable terms as provided for by the terms of contract no. CTS-0201610 awarded by the National Science Foundation of the U.S.

### TECHNICAL FIELD

The present invention is generally related to fluid processes and, more particularly, is related to a system and method for manipulating fluid samples.

### BACKGROUND OF THE INVENTION

Many technological applications, such as biomedical testing, depend upon precise control of fluid flow at small scales. Miniaturization promises to do for biomedical testing what it did for electronics (integrated circuits): creating new technology, improving speed, and slashing costs. Today some biomedical testing is performed on chips that are essentially microscale laboratories. These labs-on-a-chip can perform the same specialized functions as their room-sized counterparts. The typical lab-on-a-chip is a thin glass or plastic plate, a few centimeters on a side, with a network of microchannels etched into its surface. Typically, these microchannels are about 10 s of microns deep, 10 s of microns wide, and several centimeters in length. Electrodes are placed at strategic locations on the chip. A simple experiment begins by injecting a liquid sample (as little as several picoliters) at one end of a microchannel. Electric fields and/or pressure gradients propel the sample along a predefined route, past reservoir chambers that squirt measured amounts of reactants, and over detectors scrutinizing the progress of the reaction.

Today, labs-on-a-chip are in their infancy and much as microprocessors were at the beginning of the era of integrated circuits. Currently, research is being conducted so as to bring labs-on-a-chip to maturity. It is expected that one day, labs-on-a-chip will perform clinical diagnoses, scan DNA, run electrophoretic separations, act as microreactors synthesizing novel compounds, and be self-contained chromatographs.

Precise manipulation of biological liquids is key to the performance of labs-on-a-chip. In order to operate, such a lab-on-a-chip device must be able to perform the following microfluidic functions: pumping, metering, switching (flow), dispensing, mixing, and separating.

A problem with current labs-on-a-chip is that their architecture and hence their functionality is fixed by the microchannels, detectors, and other features. The problem expressed in electronic terms is that current labs-on-a-chip chips are essentially “hard wired” and each chip is designed for a specific purpose. Today, there are no general microfluidic chips that may be used for more than one purpose. Thus, what is sought is a microfluidic chip with dynamically reconfigurable architecture.

Another problem with current chips is that they are normally “use-once-and-throw-away”. Generally, after a chip has been used to test a sample, it is impossible to clean, and consequently it cannot be used again to test another sample. Thus what is sought is a microfluidic chip that can be used more than once.

Thus, a heretofore-unaddressed need exists in the industry to address the aforementioned deficiencies and inadequacies.

### SUMMARY OF THE INVENTION

Embodiments of the present invention provide a unit and method for manipulating fluids.

Briefly described, in architecture, one embodiment of the unit, among others, can be implemented as follows: a substrate that receives a fluid; and an optical surface-tension gradient inducer adapted to optically induce a gradient in surface tension of the fluid.

Another embodiment of the present invention can also be viewed as providing methods for manipulating fluids. In this regard, one embodiment of such a method, among others, can be broadly summarized by the following steps: providing a given fluid; and optically inducing a gradient in the surface tension of the given fluid.

Other units and methods of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of a micro-fluidic processor.

FIG. 2 is a block diagram of a surface tension gradient inducer of FIG. 1.

FIGS. 3(A)-3(C) are a sequence of block diagrams of a fluid droplet and a fluidic probe being driven together, merged, and mixed.

FIGS. 4(A)-4(B) are block diagrams of microfluidic chips using liquid and gaseous substrates of FIG. 1.

FIG. 5 is a block diagram of a micro-fluidic chip of FIG. 1.

FIG. 6 is a block diagram of a micro-fluidic chip of FIG. 1.

FIG. 7 is a block diagram of the micro-fluidic processor of FIG. 1 and a fluid sample dispenser and fluidic probe dispenser.

FIG. 8 is a flow chart of steps taken for thermally cycling a biological sample.

FIG. 9 is a fluid film on a plate.

FIG. 10 is a flow chart of steps taken for manipulating a thin film.

### DETAILED DESCRIPTION OF THE PREFERRED EMBODIMENT

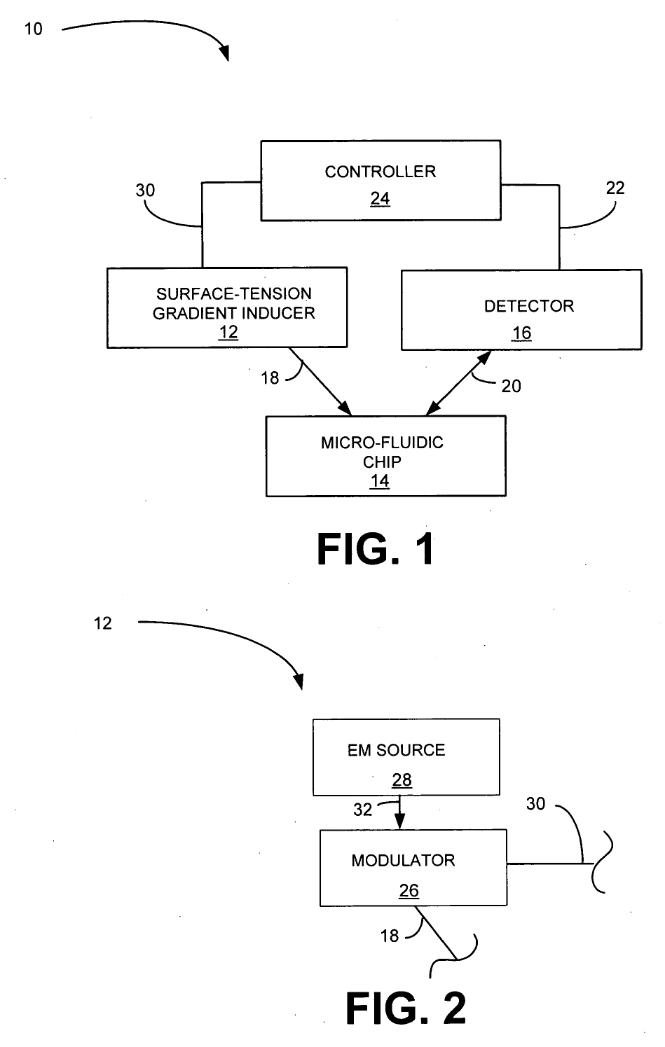

Referring to FIG. 1, a fluidic processor 10 includes a surface tension gradient inducer (STGI) 12, a micro-fluidic chip 14, a detector 16, and a controller 24. The STGI 12 emits electromagnetic (EM) radiation 18, which is incident upon the micro-fluidic chip 14 and which, will be explained in detail hereinbelow. The EM radiation 18 is typically a beam of light, which in one embodiment is coherent light, such as a laser beam. In another embodiment, the EM radiation 18 is incoherent light. Generally, the wavelength of the EM radiation 18 is in the range of visible light, but it may also be outside the visible light spectrum. For the purposes of this disclosure, the visible light spectrum is defined as approximately 400 nanometers (nm) to 700 nm.

The detector 16 monitors the micro-fluidic chip 14 and is in communication with the controller 24 via communication path 22 and provides the controller 24 with data collected from the micro-fluidic chip 14. Among other things, the detector 16 detects fluidic probes (not shown) and fluid samples that are disposed on the micro-fluidic chip 14. The detector 16 is usually adapted to detect, among other things, chemical reactions, biological reactions, and biological activity involving fluid samples and fluidic probes.

In one embodiment, the detector 16 includes capacitive devices that sense fluidic probes and fluid samples by measuring changes in electrical capacity due to the presence of fluidic probe and/or fluid samples. The detector 16 may also include resistive devices and/or inductive devices for detecting, among other things, fluidic probes and fluid samples, by changes in electrical induction due to the presence of probes and samples.

In one preferred embodiment, the detector 16 receives EM radiation 20 from the micro-fluidic chip 14. Among other things, the EM radiation 20 may be EM radiation that is reflected from diffracted from, fluoresced from the micro-fluidic chip 14. Typically, the detector 16 includes a digital video camera for receiving and detecting EM radiation 20.

In one preferred embodiment, the controller 24 is a general-purpose computer such as a personal computer. In an alternative embodiment, the controller 24 can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Among other things, the controller 24 includes the logic form analyzing data from the detector 16 and providing instructions to the STGI 12, via electrical connector 30. Typically, the analyzing logic includes logic for determining the dynamic state of the micro-fluidic chip including detected fluidic probes and fluid samples and may include logic for determining, among other things, the dynamic state of fluid flow, physical changes, chemical reactions and biological reactions.

Referring to FIG. 2, the STGI 12 includes a modulator 26, and an EM source 28. Based at least upon the information from the detector 16, the controller 24 provides instructions to the modulator 26. The modulator receives commands from the controller 24 via an electrical connection 30, which can be wired or wireless.

The controller 24 receives information from the detector such as, but not limited to, the current position and state of a sample in the micro-fluidic chip 14, the current position and state of at least one fluidic probe, and the results of chemical reactions or biological reactions between a sample and at least one probe. In one preferred embodiment, the controller 24 includes logic for determining the state of fluids such as, but not limited to, the fluidic probe and the sample. As will be explained in detail hereinbelow, in one embodiment, the controller receives information related to a fluid film and includes logic for determining the state of the fluid film.

The EM source 28 provides EM radiation 32 to the modulator 26. The EM source 28 is typically a laser or a high intensity arc lamp. Typically, the EM source 28 is chosen based upon the frequency of the emitted EM radiation 32 and upon the absorptive properties of micro-fluidic chip 14.

The modulator 26 receives the EM radiation 32 from the EM source 28 and instructions from the controller 24. The modulator 26 is adapted to modulate the input EM radiation 32 and output it as modulated EM radiation 18. Among other things, the modulator 26 is adapted to modulate at least the intensity of the EM radiation 18. Typically, the modulator 26 is adapted to provide temporal and spatial modulation such that the EM radiation 18 is incident upon the micro-fluidic chip 14 according to instructions provided by the controller 24. For example, the modulator 26 can raster the EM radiation 18 across selected portions of the micro-fluidic chip 14. Typically, the modulator 26 is also adapted to split the input EM radiation 32 and output more than one beam of EM radiation 18. Modulator 26 may also modulate different regions of a single extended beam to provide temporal and spatial modulation of electromagnetic radiation that is incident on micro-fluidic chip 14.

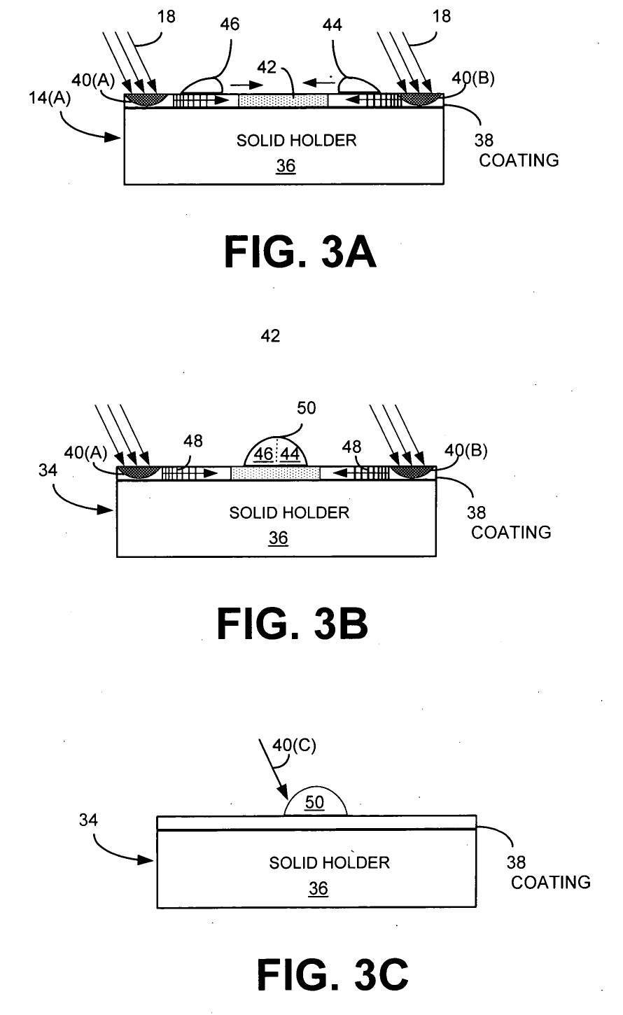

Referring to FIG. 3A, a micro-fluidic chip 14(A) includes in one embodiment, a solid holder 36, a coating 38, a fluidic probe 44, and a fluid sample 46. Typically, the coating 38 is made from a non-wetting material or partially wetting material so that the fluidic probe 44 and fluid sample 46 bead on the coating 38 instead of spreading out. Normally, the coating is made from a material, which will readily absorb EM radiation 18. As those skilled in the art will recognize, the coating is optional and is not included in an alternative embodiment.

FIGS. 3A through 3C represent a sequence of snapshots of the probe 44 and sample 46 being driven together (merged) and then mixed. As illustrated in FIGS. 3A and 3B, EM radiation 18 is incident upon the coating 38, which absorbs the radiation. Regions 40(a) and 40(b) represent regions of the coating 38 that have been directly heated by the incident EM radiation 18. The EM radiation 18 is incident upon the microfluidic chip 14(A) such that temperature gradients 48 are produced. Region 42 represents a region having no temperature gradient.

The fluidic probe 44 and fluid sample 46 experience thermocapillary effects from being in the thermal gradient 48. The fluidic probe 44 and fluid sample 46 are each sized such that surface tension is the predominant driving force for each of them. Typically, the fluidic probe 44 and fluid sample 46 each have a volume that is approximately in the microliter range or smaller, i.e., the volume is approximately less than or equal to 10,000 nanoliters. Because the surface tension is the predominant driving force for the fluidic sample 46 and the fluidic probe 44, thermocapillary effects are used to manipulate them. Specifically, fluids at this scale undergo translation, merging, mixing, splitting and metering, among other things, due to thermocapillary affects.

The imposed temperature gradient 48 induces thermocapillary effect on the interface of the fluidic probe 44 and the fluid sample 46 which causes fluid at the surface of the droplets to flow (fluidic probe 44 and fluid sample 46) towards the cooler side of the droplets. The net effect of this flow is the overall migration of the droplets towards the unheated region 42, resulting in migration of the droplet.

In FIG. 3B, the fluidic probe 44 and fluid sample 46 have merged together to form a single droplet 50. However, absent other driving mechanisms, molecular diffusion governs the mixing of the fluidic probe 44 with the fluid sample 46 within the droplet 50. Generally, molecular diffusion is a slow process, typically, taking hours or longer at the nanoliter scale for the fluidic probe 44 and fluid sample 46 to mix together.

FIG. 3C represents how EM radiation 18 is used to optically produce a mixed droplet 52. The EM radiation 18 generates a thermal gradient (not shown) across the merged droplet 50, which in turn induces a gradient in the surface tension of the merged droplet 50. Consequently, the merged droplet 50 moves away from the incident EM radiation 18. Mixing of the merged droplet 50 is promoted by causing the merged droplet to move in various directions. The area illuminated by the EM radiation 18 is periodically or continuously changed thereby causing the merged droplet 50 to move, and thereby promoting mixing. The EM radiation 18 can be incident upon the coating 38 or upon a portion of the merged droplet 50 so long as the incident EM radiation produces a thermal gradient across at least a portion of the merged droplet 50. Further details on optically manipulating fluids may be found in “Optical Manipulation of Microscale Fluid Flow,” Phys. Rev. Lett. 91, 054501 (2003), N. Gamier, R. O. Grigoriev, and M. F. Schatz; and “Contact Line Instability and Pattern Selection in Thermally Driven Liquid Films,” Phys. Fluids 15, pp. 1363-1374 (2003), R. O. Grigoriev, both of which are hereby incorporated by reference in their entirety.

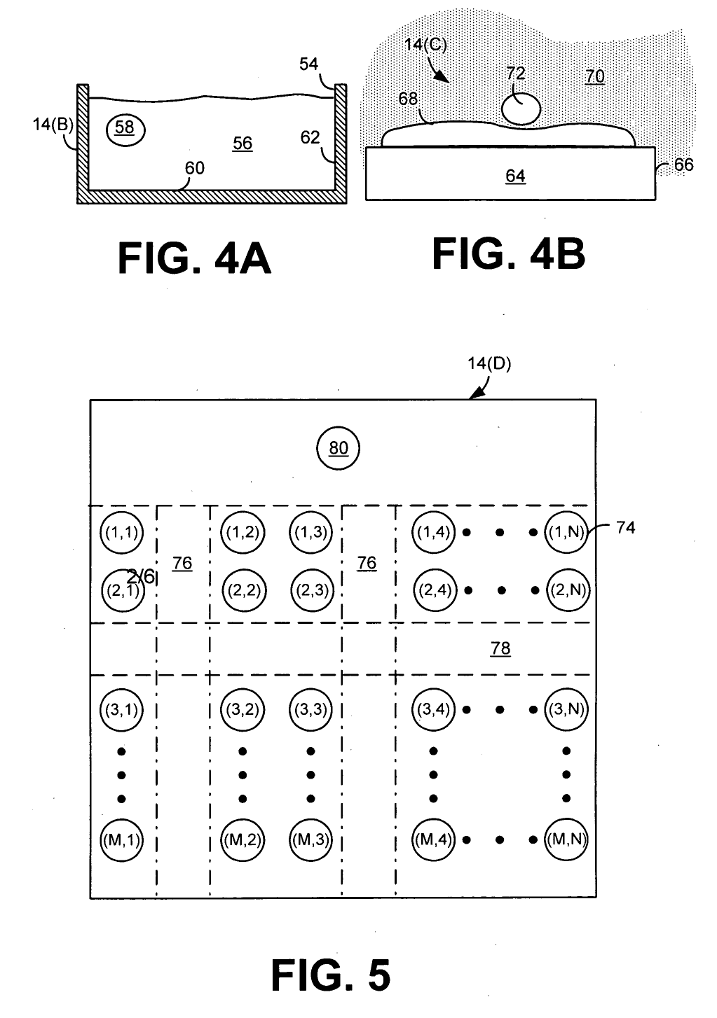

Referring to FIG. 4A, in another embodiment, the micro-fluidic chip 14(B) includes a liquid substrate 56 and a probe/sample 58 within an open container 54, which includes a bottom wall 60 and sidewall 62. In this embodiment, the liquid substrate 56 is chosen to be immiscible with respect to the probe/sample 58. Generally, the liquid substrate 56 is also chosen such that its density approximately matches the density of the probe/sample 58 so that the probe/sample 58 does not sink to the bottom wall 60 of the container 54. However, the density of the probe/sample 58 can be less than the density of the liquid substrate 56 such that the probe/sample 58 floats on or near the surface of the liquid substrate 56. Furthermore, the liquid substrate is typically chosen for its ability to absorb EM radiation at specific frequencies, but thermocapillary flow may be induced in either the substrate 56 or in the probe/sample 58 or in both.

Generally the probe/sample 58 is aqueous and is used for, among other things, carrying organic molecules (e.g., proteins, DNA), inorganic molecules (e.g., dissolved toxic gases, pollutants) or microparticles (e.g., suspensions, colloids or biological cells). Examples of liquid substrates 56 used for aqueous droplets include immiscible fluids such as, but not limited to, silicone oils (polydimethyl siloxanes) and perfluorocarbon liquids.

Referring to FIG. 4B, in yet another non-limiting embodiment, a micro-fluidic chip 14(C) includes a solid holder 64 having an upper surface 66 and a liquid 68 disposed thereon. Suspended in a gas 70 above the liquid 68 is a droplet 72. The droplet 72 is at a temperature that is hotter than the temperature of the liquid 68. The gas 70 provides a cushion that separates the fluid 68 from the droplet 72. The gas 70 serves as a lubricant between the droplet 72 and the liquid 68. Typically, the droplet 72 is a probe that is used for testing other fluid droplets, which are also suspended in the gas above the liquid, having a sample therein. For further details regarding suspending a droplet on a cushion of gas, see Noncoalescence and Non-Wetting Behavior of Liquids, Annual Review of Fluid Mechanics 34, pages 267-289, 2002, G. P. Neitzel and P. Dell Aversana. In yet another embodiment, the droplet 72 can be suspended in the gas 70 above the upper surface 66.

In operation, a fluid sample (not shown) would be disposed on the micro-fluidic chip illustrated in FIGS. 4A, and the STGI 12 would then cause the sample to be merged and, when appropriate mixed with the probe. Generally, the viscous frictional forces experienced by the fluid samples and the fluidic probes disposed on micro-fluidic chips 14(B) and 14(C) are less than the viscous frictional forces for fluid samples and fluidic probes disposed on the micro-fluidic chip 14(A). Thus, it is generally faster to move fluid samples and fluidic probes using micro-fluidic chips 14(B) and 14(C) than it is using micro-fluidic chip 14(A).

Referring to FIG. 5, in one embodiment a micro-fluidic chip 14(D) includes a plurality of fluidic probes 74 arranged in a grid-like manner. The probes 74 are arranged such that they define longitudinal and transverse channels (76 and 78), respectively. Typically, the probes 74 are different from each other and are chosen such that they chemically react with, i.e., test for, different compounds, molecules, reactants, etc.

In operation, a fluidic sample 80 is disposed in the micro-fluidic chip 14(D). The STGI 12 then optically guides the fluidic sample 80 into the grid of probes 74 such that the sample 80 is merged with a selected probe such as probe (1,1). The channels 76 and 78 provide passageways for the sample 80 through the grid of probes. After the sample 80 and a probe have merged together, they are then mixed together by the STGI 12.

The detector 16 monitors both, the position of the sample 80 and the probes 74. If any of the probes 74 moves too far from their grid locations, the controller 74 signals the modulator 26 to direct EM radiation 18 to locations specified by the controller 24 so that the probes remain in a general grid-like arrangement.

The detector 16 also detects whether the sample 80 chemically reacts with a probe 74 when they are mixed together. In one embodiment, the probe 74 includes dyes that may chemically react with the sample 80 depending upon, among other things, the chemical and/or molecular composition of the sample 80. In one embodiment, the detector 16 measures whether or not the sample 80 and a probe 74 have chemically reacted based on, e.g. the absorption of the EM radiation by the mixed droplet. In one embodiment, the detector 16 is adapted to, among other things, measure fluorescence, spectral intensity and/or frequency shift, and to detect the sample 80 and probe 74 and products of chemical reactions between the sample 80 and probe 74.

In one embodiment, at least some of the probes 74 are chemically inert with respect to other probes. Chemically inert probes can be mixed together without contaminating the result of the testing of the sample. Thus, if probes (1,1), (2,1), and (1,2) are chemically inert with respect to each other, then the sample 80 can be first mixed with one of the probes such as probe (1,1). Then, if the result is negative, the mixed droplet can then be mixed with another probe such as probe (2,1). On the other hand, if the result of mixing probe (1,1) and sample 80 had not been negative, then the mixed droplet is then mixed with probe (1,2), and so on.

The controller 24 uses the modulator 26 to guide the sample and/or mixed droplets through the grid of probes 74 along the channels 76 and/or 78 to selected probes. In this manner, the sample and/or the mixed droplet, is brought into contact with multiple probes for analysis. In one embodiment, multiple samples are disposed on/in the micro-fluidic chip, and the controller 24 manipulates the samples in parallel.

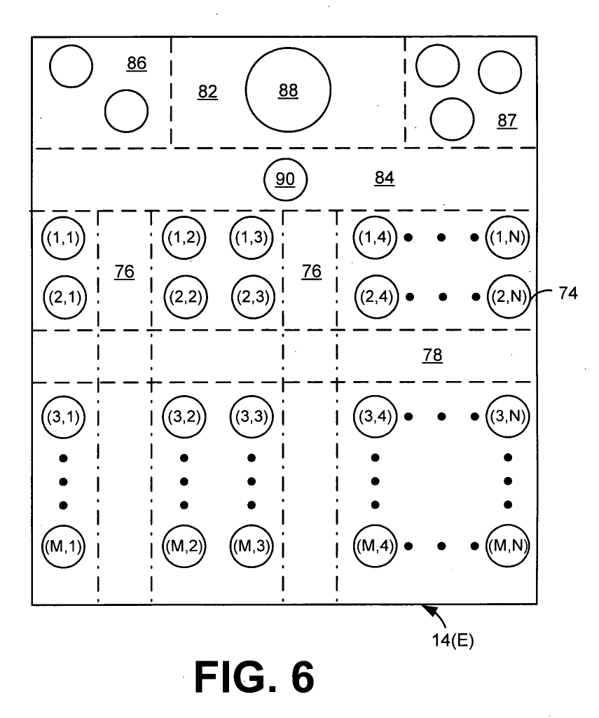

Referring to FIG. 6, in an alternative embodiment, a micro-fluidic chip 14(E) includes an array of probes 74 arranged in a grid-like manner.

The micro-fluidic chip 14(E) defines a sample storage zone 82, a test zone 84, a trash zone 86, and a tested droplet storage zone 87. The sample storage zone 82 is used for storing a root sample 88 and/or receiving a sample for testing. Generally, the root sample 88 is larger than an actual test sample such as test sample 90, but the root sample 88 is still small enough such that it can be manipulated by the STGI 12. The test zone 84 is where test samples and fluidic probes are tested. Generally, after a sample has been fully tested, the droplet is moved into the trash zone 86. However, sometimes it may be desirable to keep the tested droplet for, among other reasons, further testing, and in that case, the tested droplet is then moved into the tested sample zone.

In operation, the STGI 12 manipulates the root sample 88 such that the root sample 88 is split into two portions, thereby yielding the test sample 90 and the root sample 88. The test sample 90 is then guided by the STGI into the test zone 84. One or more fluidic probes 74 are then guided through the channels, if necessary, into the test zone 84. In the test zone 84 the test sample 90 is merged and mixed with one or more probes that are brought into the test zone 84. Upon completion of testing, the tested droplet is moved into either the trash zone 86 or the tested droplet storage zone 87. The tested droplet storage zone 87 contains droplets that have been tested, but may require further testing and/or archiving.

In one embodiment, the storage zones 82 and 87 and trash zone 86 are not included in the micro-fluidic chip (see FIG. 5). Instead, a sample reservoir is in fluidic communication with the micro-fluidic chip, and a test sample is then introduced into the micro-fluidic chip. Similarly, a trash zone is also in fluidic communication with the micro-fluidic chip, and tested droplets are then removed from the micro-fluidic chip. In addition, the tested droplet storage zone is also in fluidic communication with the micro-fluidic chip for storing tested samples.

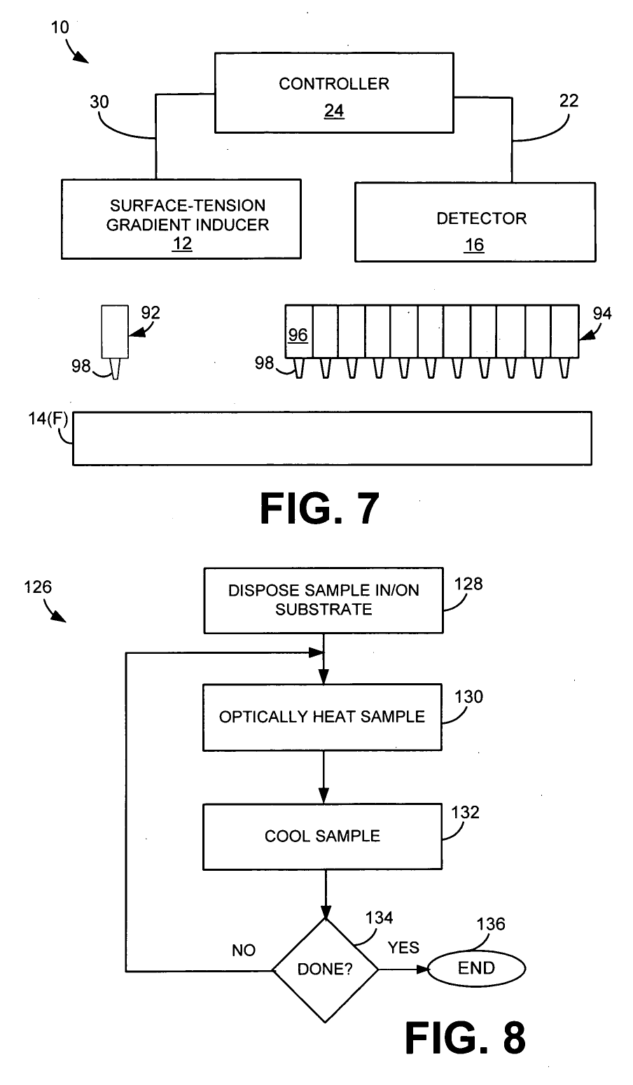

Referring to FIG. 7, in one embodiment, a fluidic processor 10 also includes a sample reservoir 92 and a fluidic probe reservoir array 94. The fluidic probe reservoir array 94 includes multiple fluidic probe reservoirs 96, each containing a fluidic probe therein. The fluidic probe reservoirs 96 are arranged in a predetermined manner. A nozzle 98 extends downward from each of the fluidic probe reservoirs 96 and from the sample reservoir 92. The nozzles 98 are adapted to release a nanoliter-sized droplet onto/into the micro-fluidic chip 14(F). Generally, the fluidic probe reservoir array 94 is similar to arrays of micropipettes.

After the sample reservoir 92 and the fluidic probe reservoir array 96 have released droplets of a sample and of probes (respectively) onto/into the micro-fluidic chip 14(F), the sample reservoir 92 and the fluidic probe reservoir array 94 are positioned so that the STGI 12 can perform the desired operations. Generally, the fluidic probe reservoir array 94 releases the droplets of probes such that the probes are in a predetermined arrangement such as the grid-like arrangement illustrated in FIGS. 5 and 6.

In an alternative embodiment, a fluidic chip is in fluidic communication with reservoirs containing fluidic probes and samples. When fluid from a reservoir is released, the STGI is implemented to meter out nanoliter-sized droplets. In other words, as fluid from a reservoir emerges, the STGI manipulates the surface tension of the fluid such that a nano-sized droplet is effectively “pinched off”, i.e., metered, from the fluid. The STGI then guides the droplets to the desired location in the micro-fluidic chip.

Referring to FIG. 8, steps 126 illustrate another implementation of the STGI 12, including but not limited to, processing including polymerase chain reaction (PCR). The STGI 12 controls reaction rates by optically imposed temperature control. The temperature control is independent of the gradient heating used to drive fluid flow.

In step 128, a biological sample is disposed in/on a substrate. Generally, the biological sample is disposed in a fluid substrate, but it may also be disposed on a solid or gas substrate. The volume of biological sample is typically less than a microliter.

In step 130, the sample is heated by electromagnetic radiation. Typically, it is preferable to heat the sample directly by irradiating the sample with electromagnetic radiation, but the electromagnetic radiation can also heat a portion of the substrate, which then heats the sample via thermal transfer. Generally, the substrate and/or the holder of the substrate acts as a thermal reservoir.

In step 132, the sample is allowed to cool. During cooling the sample is not heated via electromagnetic radiation, and heat from the sample is thermally transferred to at least the substrate.

Typically, in step 130 enough energy is absorbed by the sample that the DNA double strands in the sample separate. The sample includes primers (oligonucleotides) and aminoacids, which bond to the separated DNA strands as the sample cools, thereby replicating/copying the DNA sequences.

In step 134 a decision regarding whether the processing of the sample is complete is performed. If the processing is complete, the processing ends at step 136, otherwise the processing repeats steps 130-134. The determination in step 134 may be based upon the number of times the process has completed step 130 and 132 or based upon other criteria such as, but not limited to, detecting and determining the DNA concentration.

It should be noted that an advantage of using electromagnetic radiation to heat samples having volumes less than microliters is that the sample can be cycled through heating and cooling very rapidly. Instead of taking hours to perform PCR essays, the process could normally be performed in less than one hour and sometimes in a matter of minutes.

In certain situations, the STGI 12 could be used to heat, merge, mix, split, meter, and move samples. It should be noted that the STGI can be used to carefully apply a predetermined amount of heat, given the specific heat capacity of the sample, the absorption coefficient of the sample, and, in the case of a fluid substrate, the absorption coefficient of the substrate, and other data, such as the power output of the STGI. The controller can calculate the amount of time to irradiate the sample to raise the temperature of the sample to a desired temperature. Furthermore, it should be noted that optical temperature control can be implemented independently of thermal gradient control.

Although the present invention has been described in terms of manipulating droplets, which are generally of nanoliter size that was done for the sake of clarity. The present invention can also be used to manipulate continuous streams and films of fluids. Many industrial processes such as applying polymeric materials to wafers during semiconductor manufacture require the spreading of thin films (1-100 micrometer depth). Instabilities during the spreading process can cause undesired nonuniform coating.

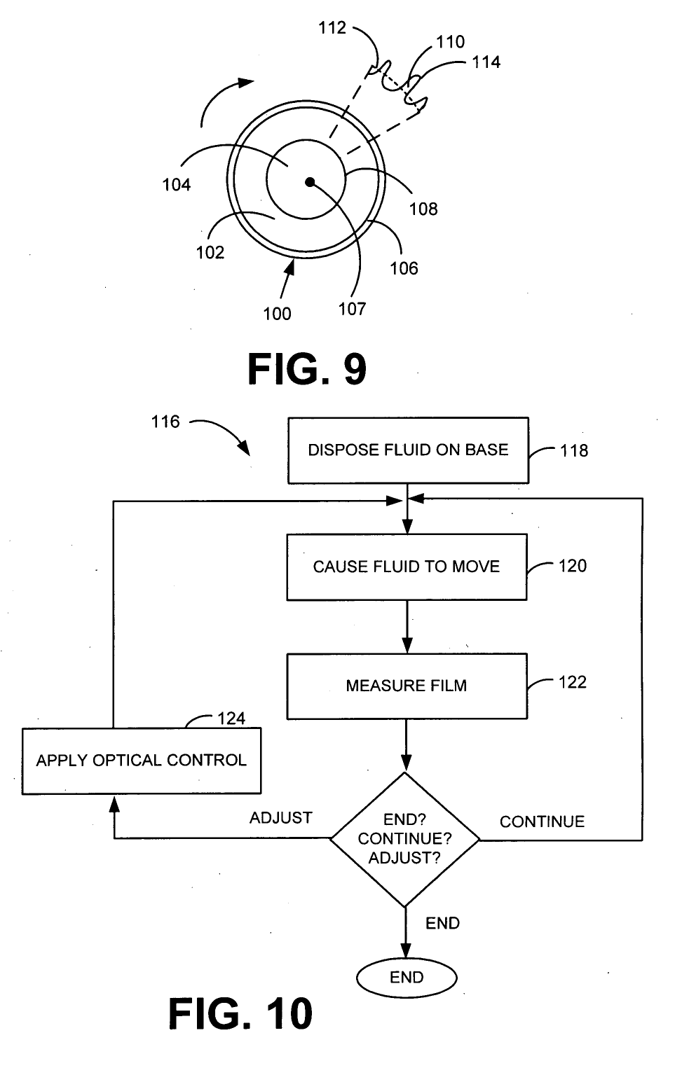

Referring to FIG. 9, a rotatable plate 100 is adapted to receive a base 102 upon which a fluid 104 is disposed. FIG. 9 illustrates the plate 100 and base 102 as seen from above and with the axis of rotation of the plate being perpendicular to the paper. In one embodiment, the plate 100 is essentially flat and has a raised outer lip 106, which prevents the base 102 from becoming dislodged from the plate 100 as the plate 100 and base 102 are rotated. In another preferred embodiment, the base 102 is removably coupled to the plate 100 by techniques well known to those skilled in the art such as, but not limited to, inducing a vacuum underneath the base so as to hold the base onto the plate.

Generally, the fluid 104 is disposed approximately on the axis of rotation 108. The spinning of the base 102 causes the fluid 104 to spread outward from the axis of rotation 107 under the action of centrifugal force. The moving fluid 104 defines a fluid front 108, which may appear to be uniform. However, at the fluid front 108, the flow of the fluid is generally not uniform. Instead, the fluid from 108 normally tends to form rivulets 110.

In one preferred embodiment of the invention, the detector 16 is adapted to detect the formation of rivulets using interferometry techniques or other techniques known to those skilled in the art. The controller 24 receives information from the detector 16 and uses the information to determine or partially determine the state of the fluid 104, e.g., thickness profile, position of the fluid front, etc. For example, in one preferred embodiment, the controller 24 can determine a target fluid front 112, which corresponds to where the actual fluid front would be if the fluid 104 were flowing in the desired manner. For example, it may be desired that the fluid coat the surface in a predetermined pattern, or a predetermined thickness, etc. The target fluid front 112 can be calculated using the detected position of the actual fluid front and other criteria.

After calculating the target fluid front 112, the controller 24 instructs the STGI 12 to apply EM radiation to the base 102 and/or to the fluid 104 such that the propagation of rivulets is either inhibited (to produce uniform coverage) or enhanced (to achieve selective patterning). For instance, the STGI 12 may provide EM radiation to the base 102 indirectly inducing a thermal gradient at the front 114 of the rivulet 110. In addition, EM radiation may also be applied directly to one or more portions of the rivulet 110 including the rivulet front 114. For example, the entire length of the rivulet can be patterned with EM radiation. In other words, portions of the fluid 104, which are behind and/or in front of the target fluid front 112, can be patterned with EM radiation.

Referring to FIG. 10, steps 116 are exemplary steps that are implemented for providing control of a fluid film. In step 118, a fluid is disposed on a base. If the base is to be spun, then the fluid is normally disposed on the center of rotation of the base.

In step 120, the fluid flows from where it was disposed. Generally the base is spun thereby causing the fluid to flow radially outward. However, as those skilled in the art are well aware, other methods for causing the fluid to flow exists and are intended to be included within the scope of the invention. For example, in one embodiment, the base is oriented such that the fluid flows under the influence of gravity.

In step 122, observables, which are related to the state of the film, are measured. The measured observables can include, but are not limited to, thickness profile, position of the front, and other properties. The controller uses measured observables to calculate the current state of the film.

In step 123, the controller determines whether the film dynamics is within established parameters or needs optical control. If the film dynamics is outside of the established parameters, the controller determines how much and where to apply EM radiation so as to bring the film back into the established parameters.

In step 124, the STGI 12 is implemented to induce the fluid to flow in a desired manner such that the dynamics of the film is within the established parameters. Normally the desired fluid flow is for the fluid to coat the base with a uniform density, but, in some situations, that may not be desired. Thus, the STGI 12 induces gradients in the surface stress of the fluid to cause it to flow in a predetermined/desired manner. The system keeps cycling through steps 120, 122, 123, and 124 until the fluid has coated the base in the desired manner.

It should be noted that any process descriptions or blocks in flow charts should be understood as the steps illustrated in flow charts are for illustrative purposes and that in alternative embodiments, fewer or more steps might be implemented. Also, in alternative embodiments, the step illustrated herein might be performed out of order from that shown or discussed, including substantially concurrently or in reverse order, depending on the functionality involved, as would be understood by those reasonably skilled in the art of the present invention.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims

1. A fluidic processing unit comprising:
a substrate adapted to receive a fluid; and
an optical surface-tension gradient inducer adapted to optically induce a gradient in surface tension of a fluid.

2. The fluidic processing unit of claim 1, wherein the substrate is selected from a set of substrates consisting of solid substrates, gas substrates, and liquid substrates.

3. The fluidic processing unit of claim 2, wherein the solid substrate is a rotatable plate.

4. The fluidic processing unit of claim 2, wherein the liquid substrate is immiscible with respect to a fluidic probe.

5. The fluidic processing unit of claim 2, wherein the substrate is essentially featureless.

6. The fluidic processing unit of claim 5, wherein the substrate is essentially inert with respect to a fluidic probe and a sample.

7. The fluidic processing unit of claim 5, wherein the substrate is a solid substrate having an essentially non-wetting surface for receiving a fluidic probe.

8. The fluidic processing unit of claim 1, wherein the optical surface-tension gradient inducer includes:
an electromagnetic (EM) illuminator adapted to generate electromagnetic radiation; and
a modulator adapted to modulate the EM radiation produced by the EM illuminator.

9. The fluidic processing unit of claim 8, wherein the modulator patterns the substrate with EM radiation such that the EM radiation is incident upon the substrate and produces a temperature gradient in the substrate and induces a gradient in surface tension across a given fluid, wherein the given fluid is at least one fluid selected from the set of fluids consisting of a fluidic probe, a fluid sample, a fluid sample merged with a fluidic probe, a fluidic sample mixed with a fluidic probe, and products from chemical reactions between a fluid sample and a fluid probe.

10. The fluidic processing unit of claim 8, wherein the modulator patterns a fluidic probe with EM radiation such that the EM radiation induces a gradient in the surface tension of the probe.

11. The fluidic processing unit of claim 8, wherein the EM illuminator is selected from a light source consisting of incoherent light sources and coherent light sources.

12. The fluidic processing unit of claim 1, further including:
a detector adapted to detect a given fluid, wherein the given fluid is at least one fluid selected from the set of fluids consisting of a fluidic probe, a fluid sample, a fluid sample merged with a fluidic probe, a fluidic sample mixed with a fluidic probe, and products from chemical reactions between a fluid sample and a fluid probe; and
a controller in communication with the detector, the controller adapted to control the modulator using at least information provided by the detector.

13. The fluidic processing unit of claim 12, wherein the detector includes at least one of a capacitive detector, an inductive detector, and a video camera.

14. A fluidic processing unit comprising:
a substrate means for receiving a fluid; and
an optical surface-tension gradient inducer means for optically inducing a gradient in surface tension of the fluid.

15. The fluidic processing unit of claim 14, wherein the optical surface-tension gradient inducer means includes:
electromagnetic (EM) illumination means for generating electromagnetic radiation; and
modulation means for modulating the EM radiation produced by the EM illumination means.

16. The fluidic processing unit of claim 14, further including:
a detector means for detecting the fluid, wherein the fluid is at least one fluid selected from the set of fluids consisting of a fluidic probe, a fluid sample, a fluid sample merged with a fluidic probe, a fluidic sample mixed with a fluidic probe, and products from chemical reactions between a fluid sample and a fluid fluidic probe; and
a controller means in communication with the detector means, the controller means for controlling the modulation means using at least information provided by the detector means.

17. The fluidic processing unit of claim 16, wherein the detector means includes at least one of a capacitive detector, an inductive detector, and a video camera.

18. A method of manipulating a given fluid, the method comprising the steps of:
providing a substrate;
providing a given fluid; and
optically inducing a gradient in the surface tension of the given fluid.

19. The method of claim 18, further including the step of:
generating a thermal gradient in at least a portion of the substrate by illuminating at least a portion of the substrate with electromagnetic (EM) radiation.

20. The method of claim 18, further including the steps of:
providing a second fluid; and
optically inducing the given fluid and the second fluid to merge together.

21. The method of claim 18, further including the steps of:
optically mixing the merged given fluid and second fluid.

22. A method of producing a substantially uniform film on an object, the method comprising the steps of:
disposing a fluid on the object at a given point;
causing the fluid to flow away from the given point, wherein the flowing fluid defines a fluid front; and
optically enhancing uniform flow at the fluid front

23. The method of claim 22, further including the step of:
optically inhibiting the propagation of a rivulet at the fluid front, wherein the rivulet propagates along a rivulet front.

24. The method of claim 23, further including the steps of:
determining a target fluid front;
determining whether the rivulet crosses the target fluid front;
responsive to the rivulet crossing the target fluid front, optically inducing a gradient in the surface tension of the rivulet.

25. The method of claim 24, further including the step of:
creating a thermal gradient in a given region of the object by irradiating the given region with electromagnetic radiation.

26. The method of claim 24, further including the step of:
creating a thermal gradient in a given region of the rivulet by irradiating the given region with electromagnetic radiation.

27. A method of processing a biological agent, the method comprising the steps of:
providing a droplet of a biological agent, wherein the volume of the droplet is approximately less than a microliter;
optically heating the droplet;
allowing the heated droplet to cool.

28. The method of claim 27, further including the steps of:
determining whether the processing of the droplet is complete; and
responsive to determining the processing is not completed, repeating steps (b) through (d), inclusive.

29. The method of claim 27, further including the step of:
repeating steps (b) and (c) a predetermined number of times.
